(19) United States
(12) Patent Application Publication
(10) Pub. No.: US 2007/0203013 A1
(43) Pub. Date: Aug. 30, 2007

(54) Ceramic Batch And Associated Product For Fireproof Applications

(75) Inventor: Harald Harmuth, Leoben (AT)

Correspondence Address: WALKER & JOCKE, L.P.A., 231 SOUTH BROADWAY STREET, MEDINA, OH, 44256, US

(73) Assignee: REFRACTORY INTELLECTUAL PROPERTY GMBH & CO. KG, Wien (AT)

(21) Appl. No.: 10/598,543

(22) PCT Filed: Mar. 3, 2005
(86) PCT No.: PCT/EP05/02226

§ 371 Date: Sep. 2, 2006

(30) Foreign Application Priority Data
Mar. 5, 2004 (DE) 10 2004 010 739.4
Mar. 5, 2004 (DE) 10 2004 010 740.8

(51) Int. Cl. C04B 35/66; C04B 35/01

(52) U.S. Cl. 501/133; 501/122; 501/128

(57) ABSTRACT

The intention relates to a ceramic batch for fireproof uses, comprising 83-99.5 wt. % of at least one refractory base material in a grain traction of <8 mm and 0.5-12 wt. % of at least one separate, granular SiO₂ carrier and any remainder: other constituents. The invention also relates to a product using this batch.

The invention relates to a ceramic batch and a associated product for fireproof (refractory) uses.

Ceramic batches comprising refractory base materials serve for the production of fireproof ceramic products and are used in many areas of industry, in particular for the lining and repair of metallurgical melting vessels or industrial furnace linings. Such base materials are furthermore employed for the production of so-called functional products, for example for spouts, immersion pipes, shadow pipes, slide valve plates etc., such as are required in the melting units and furnaces mentioned.

The refractory base materials are both basic and non-basic types. MgO, in particular MgO sinter, is an essential constituent of all MgO and MgO-spinel products. The main constituent of MgO sinter is periclase. The essential base raw material for the preparation of MgO sinter is magnesite, that is to say magnesium carbonate, or a synthetic source of magnesia.

To adjust certain material properties, in particular to improve the chemical resistance to slag, to improve the ductility and the resistance to temperature changes and the heat resistance, various fireproof ceramic batches in combination with various additives are known, from which the corresponding non-shaped or shaped products are then produced.

These include, for example, chromium ore for the production of so-called magnesia chromite bricks. Their advantage lies in a low brittleness (or higher ductility) compared with pure magnesia bricks. Nevertheless, there is an increasing demand for Cr₂O₃-free fireproof building materials in order to avoid the potential for the formation of toxic Cr⁶⁺.

Various batches which are free from chromium oxide have been proposed in this connection. According to DE 44 03 869 C2, such a batch comprises 50 to 97 wt. % sintered MgO and 3 to 50 wt. % of a spinel of the herzynite type. In contrast to pure MgO products, products fired from such a batch have a reduced brittleness.

Non-shaped products, for example casting compositions, are formed from batches which are brought into a desired processing consistency having a certain viscosity by means of water or other liquids and optionally additives (such as binders, liquefiers, dispersing agents). The compositions are then processed directly as monolithic compositions, for example for monolithic lining of a metallurgical melting vessel, or they are used for the production of so-called prefabricated components. In this case, the batches can also be processed, for example poured into moulds, as such or in combination with certain additives.

In the case of the casting compositions mentioned, which also include refractory concrete compositions, cracks can form on subsequent drying and/or shrinkage during later sintering, these reducing the life of the lining or of the prefabricated component.

Such cracks are often observed in the lining of casting ladles of the steel industry with non-basic casting compositions. In order to counteract this, spinel-forming compositions have been proposed in the prior art. During the formation of spinel, an increase in volume occurs, which counteracts shrinkages. However, the formation of cracks often already occurs at temperatures which are below the temperatures for the formation of spinel. The desired longer service lifes then cannot be achieved.

The products mentioned which are based on MgO in combination with various spinels have proved themselves in principle. However, by introducing the spinels, additional oxides are introduced into the batch, which can lead to a reduction in the heat resistance of the fired products. Thus, for example, the invariant point, which is the temperature of the first formation of a fused phase, in a magnesia brick with an addition of MgAl₂O₄ can be only 1,325° C. Calcium-rich infiltrates above all, such as, for example, basic slag or fused cement clinker, can then reduce the heat resistance and life.

In fired, shaped products also, the abovementioned influences, such as attack by slag, temperature changes etc., lead to an often inadequate life of the fireproof products. This applies in particular to uses where, for example, mechanical or thermomechanical stresses are to be expected. These include fireproof linings of units in which periodically changing deformations occur, for example, rotary kilns for the production of cement. However, fireproof products of reduced brittleness (or in other words: of increased “flexibility”) are also required in furnace units in the area of the steel and non-ferrous metals industry

These problems are greater in the case of basic materials than in the case of non-basic types. The reason is, inter alia, the usually lower thermal expansion and a certain glass phase content of non-basic products.

Finally, to reduce the brittleness it is known to admix to the batch a content of granular, stabilized zirconium oxide (zirconium dioxide; ZrO₂). Disadvantages of this are that only a relatively low reduction in brittleness is achieved and ZrO₂ is expensive.

The invention is based on the object of providing a ceramic batch and associated products which show a symbiosis of the required property features mentioned. In particular, the products formed from the batch should have, during use, a reduced brittleness (that is to say an improved ductility), good thermal shock properties, advantageous heat resistances and the best possible resistance to corrosion, and here at the same time should be inexpensive to produce. The term “product” includes, in particular, non-shaped and shaped products, those with and without heat treatment before use, sintered products and products which are/were heat-treated (heated) during use.

The invention is based on the finding that the brittleness of refractory products or products envisaged for refractory uses can be reduced significantly if the formation of macroscopically detectable (large) cracks is avoided and for this purpose the system is adjusted such that merely the formation of microcracks in the structure occurs. This is achieved by the addition of a separate SiO₂ carrier into the batch. By this means, the crack density (for example expressed as the number of cracks per square metre of the surface) is indeed increased. However, the cracks have a considerably lower crack width (in particular <20 μm), that is to say are significantly smaller than the macroscopically detectable cracks in products in the prior art. These microcracks do not have an adverse effect on the life of the products in the same manner. These products also withstand thermomechanical stresses during use, for example due to thermal shocks, better. Due to the fact that the SiO₂ carrier is also retained as a largely independent component after heat treatment and no fused phases are formed, the effects of the formation of microcracks are also retained after heat treatment.

The physical changes of the structure can be achieved according to the invention by addition of a separate, granular SiO₂ carrier in certain amounts by weight. In this context, the term “SiO₂ carrier” includes all crystalline SiO₂ modifications which have an adequate stability at room temperature. These include, primarily, cristobalite (β form) and tridymite (γ-tridymite). Another possible SiO₂ modification is coesite. Quartz (β form) or fused quartz can likewise be used as the SiO₂ carrier. This also applies to substances which have been processed from the SiO₂ base materials mentioned by physical and/or chemical processes (pretreatment). For example, quartz can be ground, compacted, sintered and then processed into a suitable grain size. In this context, the pretreatment or processing of the SiO₂ carrier can be utilized to reduce its bulk density to values of <2.65 g/cm³, for example to values of between 2.2 and 2.5 g/cm³. By admixtures such as CaO, the chemical composition of the SiO₂ carrier can furthermore be varied.

The formation of microcracks is caused by a non-linear thermal expansion during phase conversions of the crystalline SiO₂ carrier. Such a phase conversion is e.g. that of β-quartz into α-quartz at 573° C. and the conversion of α-quartz into α-cristobalite at above 1,050° C., often at about 1,250° C. β-Cristobalite is already converted into α-cristobalite at 270° C., which is likewise associated with an expansion in volume. The desired effect is therefore already to be seen in the product of the following Example 5 after drying at 380° C.

In its general embodiment, the invention accordingly relates to a ceramic batch for refractory applications comprising
A: 83-99.5 wt. % of at least one refractory base material in a grain fraction of <8 mm, and
B: 0.5-12 wt. % of at least one separate, granular SiO₂ carrier, and
C: any remainder: other constituents.

The batch may comprise only components A and B.

The refractory base material can be a basic substance, such as doloma (that is to say fired dolomite) or magnesia (that is to say MgO), or a non-basic substance, for example based on Al₂O₃ or ZrO₂

According to one embodiment, the content of the refractory base material is 90-99 wt. %. The content of the granular SiO₂ carrier is, for example, ≧1 and/or ≦7 wt. %, in each case based on the total batch, it also being possible for the upper limit to be set at <5 wt. % or <4 wt. %.

According to current findings, during a heat treatment (in particular during firing) after shaping of the batch, the mixture of refractory base material, for example an MgO base material and crystalline SiO₂ carrier, leads to expansions during the corresponding conversions of the modification of the SiO₂ carrier, as a result of which generation of microcracks in the structure occurs. These microcracks are responsible for a reduction in the brittleness.

In contrast to magnesia products with an addition of spinels, for example herzynite, the formation of microcracks in the case of addition of the crystalline SiO₂ carrier takes place during the heating up phase of the firing process, while in the prior art a formation of microcracks is to be observed in the cooling down phase.

If a vitreous SiO₂ carrier (fused quartz) is used, the formation of cracks is based on the greater shrinkage of the refractory (fireproof) base component during cooling down after firing.

The principle of initiation of microcracks due to a separate, granular SiO₂ carrier is in principle independent of the raw material (the refractory base component) and therefore can be applied, for example, to ceramically bonded, chemically bonded, carbon-bonded, hydraulically bonded, shaped and non-shaped, tempered, fired and non-fired fireproof batches and products.

The temperature can be a criterion for the choice of the SiO₂ carrier.

Thus, for example, for the prefabricated components, casting compositions or carbon-bonded fireproof products mentioned it may be appropriate to employ cristobalite as the SiO₂ carrier. In this manner, the desired microcracks can already be formed at a very low temperature level, for example already during heating up of the casting compositions. The undesirable shrinkage cracks can thereby be avoided.

This also applies, for example, to the drying of monolithic compositions or the curing (tempering) of fireproof products bonded by synthetic resin or pitch.

Non-shaped products, such as concrete compositions or casting compositions for the production of fireproof linings or prefabricated components, are an important group for the use of the invention. These compositions can harden hydraulically or semi-hydraulically, that is to say, for example, compositions based on cement, in particular aluminous cement. The invention can likewise be used on low-cement or cement-free casting compositions, for example those based on bauxite as a non-basic refractory base material.

The dry batch (for example of bauxite and cristobalite) is mixed with the required amount of water in order to achieve a desired processing consistency. Additives, such as liquefier, are optionally admixed. The conversion of β-cristobalite into α-cristobalite described already takes place from 270° Celsius during drying.

The mode of action described is largely independent of the grain fraction of the refractory base component. Low maximum grain sizes (for example 2 mm) or low contents (for example 5 wt. %) of the coarse fraction (for example 2 to 4 mm), however, can have an adverse effect on the reduction in brittleness. Nevertheless, it has proved to be favourable if the SiO₂ carrier has a grain size d₅₀ or d₀₅ which is greater than a maximum grain (or greater than at least 95 wt. %) of the fine grain content of the refractory base material. Accordingly, 50 or 95 wt. % of the SiO₂ carrier is coarser than 95 or, respectively 100 wt. % of the fine grain of the refractory base material.

The refractory base material is typically employed in a relatively wide grain spectrum. In addition to a coarse grain content (<8 mm), for example 1-6 mm, the component can have a content of a medium grain, for example 0.25-<1 mm, and a fine grain content (flour content) of <0.25 mm.

The grain size limit between coarse grain and medium grain can also be set at 1.5 or 2 mm. The flour grain content can likewise be specified at a grain fraction of <0.125 mm (125 μm).

According to various embodiments, the abovementioned fine grain content of the fireproof base material is 10-30 wt. %, 15-25 wt. % or 25-30 wt. %, in each case based on the total batch. The medium grain content such as has been mentioned above can be, for example, of the order of 5-30 wt. %, 10-25 wt. % or 10-20 wt. %, in turn based on the total batch. The coarse grain content is calculated accordingly from the above contents of the fine grain or medium grain.

According to a further embodiment, the refractory, in particular oxidic base material in the following grain distribution is proposed:

50-60 wt. % 1-6 mm,

10-25 wt. % 0.25-<1 mm,

25-30 wt. %<0.25 mm,

the sum in each case being 100 wt. %.

According to one embodiment, the granular SiO₂ carrier has a grain size of up to 6 mm, it also being possible for the grain upper limit to be chosen at 3.0 or 1.5 mm and the grain lower limit at 0.25, 0.50, 1 or 2 mm. The SiO₂ carrier is typically present in a grain fraction of between 0.5 and 3 mm. Compared with grain sizes in the range below 1 mm, the increase in the grain size (>1 mm) at the same amount leads to a higher effectiveness in the context of the invention. A grain size of 1 to 2 mm is thus more effective than a grain size of 0.5 to 1 mm.

At least one of the following components can be chosen as the non-basic refractory base material: chamotte, sillimanite, andalusite, kyanite, mullite, bauxite, corundum raw materials, such as fused corundum or brown corundum, tabular alumina, calcined alumina, base materials containing zirconium oxide, such as zirconium mullite, zirconium corundum, zirconium silicate or zirconium oxide, titanium oxide (TiO₂), Mg—Al-spinel, silicon carbide.

Quartzite can also be used as the refractory base material, cristobalite, tridymite, coesite and/or the pretreated SiO₂ carrier mentioned then being employed as an additive.

An MgO base material having an MgO content of from 83 to 99.5 wt. % is proposed in particular as a basic refractory base material. In this case, according to various embodiments the lower limit for the MgO content is 85, 88, 93, 94, 95, 96 or 97 wt. % and the upper limit is, for example, 97, 98 or 99 wt. %.

According to one embodiment, the MgO content is 94 to 99 or 96 to 99 wt. %.

The MgO base material can comprise sintered magnesia, fused magnesia or mixtures thereof.

According to one embodiment, a proportion of the MgO content of the batch can be provided by 3 to 20 wt. % (or 3-10 wt-%), based on the total mixture, of a spinel of the herzynite type, the galaxite type or mixtures thereof. In this case, the microcracks initiated by the granular SiO₂ carrier in the heating up phase are supplemented by further microcracks due to the spinel component during the cooling down phase in the pyroprocess.

The batch can moreover comprise other constituents in relatively small amounts, for example at least one of the following components: (elemental) carbon, graphite, resin, pitch, carbon black, coke, tar.

The batch can accordingly be employed for the production of C-bonded products. This applies in particular to uses of the batches in carbon-bonded products or products which are impregnated with tar.

These include so-called ASC products, the name of which originates from the main components A (for Al₂O₃ carrier), S (for SiC and/or Si-metal) and C (for the carbon carrier). Magnesia carriers (for formation of spinel) and Mg—Al-spinels can also be constituents of the recipe. Such batches are bonded with a synthetic resin, for example a phenolic resin, as a binder. They are employed, for example, for pig iron ladles, but also for shadow pipes, immersion pipes etc.

For such products bonded with synthetic resin, the curing process can be carried out such that, for example, the conversion temperature of β-cristobalite into α-cristobalite is reached or exceeded, so that on delivery of the prefabricated shaped parts, microcracks are already present in the product. Alternatively, however, it is also possible to carry out the curing (tempering) at a lower temperature (for example 160-220°) and to shift the process of formation of microcracks to the later use. The formation of microcracks then takes place during heating up of the product after its installation.

As already stated, the batch described also serves in particular for production of fired refractory products, in particular fired refractory shaped parts. In this context, a binder, in particular a temporary binder, for example a ligninsulphonate solution, is admixed to the batch—as is conventional—and the mixture is then, for example, pressed to bricks, dried and fired. A typical firing temperature is 1,300-1,700° Celsius. A typical firing temperature for a batch comprising 96 wt. % MgO and 4% of a granular SiO₂ carrier is 1,400° C. (+/−50° C.). The following findings apply when choosing the firing temperature: Too high a firing temperature or application temperature can lead to a reduced effect of the SiO₂ carrier due to too intensive sintering (usually with involvement of fused phases) and can increase the brittleness again. In this respect, the reaction behaviour, in particular the formation of fused phases, between the SiO₂ carrier and refractory base material is to be taken into account, without preventing adequate sintering. The precise firing temperature depends in this respect on the components chosen concretely for the batch and is to be determined empirically.

The invention is explained in more detail below with the aid of various embodiment examples. In total, 5 batches (no. 1-5) with non-basic base components, one batch (no. 7) based on MgO and in each case one comparison example according to the prior art (no. 6, 8) are described, the raw material composition and the chemical composition in each case being stated in the form of an oxide analysis.

The batches of Examples 1-3 serve for the production of fired, shaped products based on non-basic base materials.

It goes without saying that a temporary binder must be admixed to the batch components. This can be, for example, sulfite waste liquor, phosphoric acid or monoaluminium phosphate. A binder clay can also be included in the recipe. Bricks or other shaped parts can be produced from the batches under conventional pressing conditions (for example 65-130 MPa) and are then fired. The firing temperature is to be chosen such that the sintering is sufficient, but is not so great that too intensive a sintering counteracts the effect of the reduction in brittleness. For this, at a given composition of the components, in particular the grain size distribution of the fine grain content of the non-basic base material and the binder are decisive.

A firing temperature of 1,450° Celsius was chosen for Example 1. The bricks produced (pressed) from batches 2 and 3 were fired at 1,550° Celsius.

Batch no. 4 serves for the production of a so-called ASC product, that is to say a C-bonded product, as has been described above, having an addition of cristobalite. Microcracks are initiated in the structure via the cristobalite conversion during tempering (400° Celsius) of the products produced from the batch.

Example 5 shows a batch for a casting composition having a content of aluminous cement. The batch was prepared by mixing with water and shaped parts were produced therefrom and were dried or tempered at temperatures of up to 380° Celsius. In addition, a comparison composition (no. 6) was produced, but without addition of cristobalite, and analogous specimens were produced and likewise dried or tempered at 380° Celsius. In order to compensate for the missing 4 wt. % cristobalite in batch no. 6, all the other base components of batch no. 5 were increased relatively by in each case 4%.

### EXAMPLE (1)

| Refractory base | | | | Oxide | |
|---|---|---|---|---|---|
| material | Grain size | | Wt. % | composition | Wt. % |
| Andalusite | 1-3 | mm | 55 | SiO₂ | 40.4 |
| Andalusite | 125 μm-<1 | mm | 16 | Al₂O₃ | 58.0 |
| Andalusite | <125 | μm | 25 | Fe₂O₃ | 0.8 |
| Quartzite | 0.5-1 | mm | 4 | TiO₂ | 0.2 |
| | | | | CaO + MgO | 0.2 |
| | | | | K₂O + Na₂O | 0.3 |

### EXAMPLE (2)

| Refractory base | | | | Oxide | |
|---|---|---|---|---|---|
| material | Grain size | | Wt. % | composition | Wt. % |
| Fused mullite | 2-4 | mm | 18 | SiO₂ | 24.3 |
| Fused mullite | 0.3-<2 | mm | 51 | Al₂O₃ | 74.3 |
| Fused mullite | <125 | μm | 22 | Fe₂O₃ | 0.8 |
| Calcined alumina | <0.1 | mm | 5 | TiO₂ | 0.1 |
| Cristobalite | 1-3 | mm | 4 | CaO + MgO | 0.1 |
| | | | | K₂O + Na₂O | 0.4 |

### EXAMPLE (3)

| Refractory base | | | | Oxide | |
|---|---|---|---|---|---|
| material | Grain size | | Wt. % | composition | Wt. % |
| Fused corundum | 3-5 | mm | 13 | SiO₂ | 5.0 |
| Fused corundum | 1-<3 | mm | 42 | Al₂O₃ | 94.6 |
| Fused corundum | <1 | mm | 15 | Fe₂O₃ | 0.1 |
| Tabular alumina | <125 | μm | 15 | TiO₂ | 0.1 |
| Calcined alumina | <0.1 | mm | 10 | CaO + MgO | 0.1 |
| Coesite | 1-3 | mm | 3 | K₂O + Na₂O | 0.2 |
| Coesite | 3-5 | mm | 2 | | |

### EXAMPLE (4)

| Refractory base | | | Wt. | Oxide | Wt. |
|---|---|---|---|---|---|
| material | Grain size | | % | composition* | % |
| Fused corundum | 2-4 | mm | 15 | SiO₂ | 20.2 |
| Fused corundum | 0.3-<2 | mm | 30 | Al₂O₃ | 78.7 |
| Bauxite | 0.3-2 | mm | 20 | Fe₂O₃ | 0.4 |
| Cristobalite | 0.5-1 | mm | 4 | TiO₂ | 0.5 |
| Tabular alumina | <125 | μm | 10 | CaO + MgO | 0.1 |
| Calcined alumina | <250 | μm | 5 | K₂O + Na₂O | 0.1 |
| SiC | <125 | mm | 5 | | |
| Si-metal | <50 | μm | 3 | | |
| Graphite | <0.5 | mm | 8 | | |
| Novolak resin | | | +1.5 | | |
| with curing agent | | | | | |
| Resol resin | | | +3.5 | | |

*based on specimen calcined under oxidizing conditions

### EXAMPLE (5)

| Refractory base | | | Wt. | Oxide | Wt. |
|---|---|---|---|---|---|
| material | Grain size | | % | composition | % |
| Bauxite | 1-3 | mm | 44 | SiO₂ | 14.9 |
| Bauxite | 125 μm-<1 | mm | 22 | Al₂O₃ | 81.0 |
| Bauxite | <125 | μm | 10 | Fe₂O₃ | 1.3 |
| Cristobalite | 0.5-1.5 | mm | 4 | TiO₂ | 1.6 |
| Calcined alumina | <250 | μm | 8 | CaO + MgO | 1.2 |
| Reactive alumina | <125 | μm | 4 | K₂O + Na₂O | 0.1 |
| Microsilica | <125 | μm | 4 | | |
| Aluminous cement | | | 4 | | |
| Dispersing agent | | | +0.2 | | |
| Citric acid | | | +0.1 | | |

Mechanical fracture tests have shown that the initiation of microcracks can reduce the brittleness. Dimension figures for the brittleness of a product can be obtained in various ways. Such a dimension figure is, for example, the characteristic length

$${l}_{ch} = \frac{{G}_{F} \cdot E}{{f}_{l}^{2}} \qquad ( I )$$

In this equation, G_{F} designates this specific fracture energy (N/m), E the modulus of elasticity (Pa) and fₜ (Pa) the tensile strength. The brittleness of the fireproof building material is lower, the higher the characteristic length. As a rule, a decrease in brittleness is observed with an increasing quotient G_{F}/fₜ of the specific fracture energy G_{F} to the tensile strength fₜ. For characterization of products according to the invention, the ratio G_{F}/σ_{KZ} is used. A wedge split test for determination of the specific fracture energy G_{F} and the nominal notched tensile strength σ_{KZ} is described in its fundamental mode of functioning in K. Rieder et el., “Bruchmechanische Kaltund Heiβprüfung feuerfester grobkeramischer Werkstoffe [Cold and hot testing of mechanical fracture of fireproof ordinary ceramic materials]”, Progress Reports of the Deutsche Kerarnische Gesellschaft, Werkstoffe-Verfahren-Anwendung [Materials-Methods-Use]-volume 10 (1995), issue 3, ISSN 0177-6983, 62-70. The test method is explained in more detail in the following:

The wedge split test is carried out at room temperature after a heat treatment of the product (for example after drying, tempering or firing of the product).

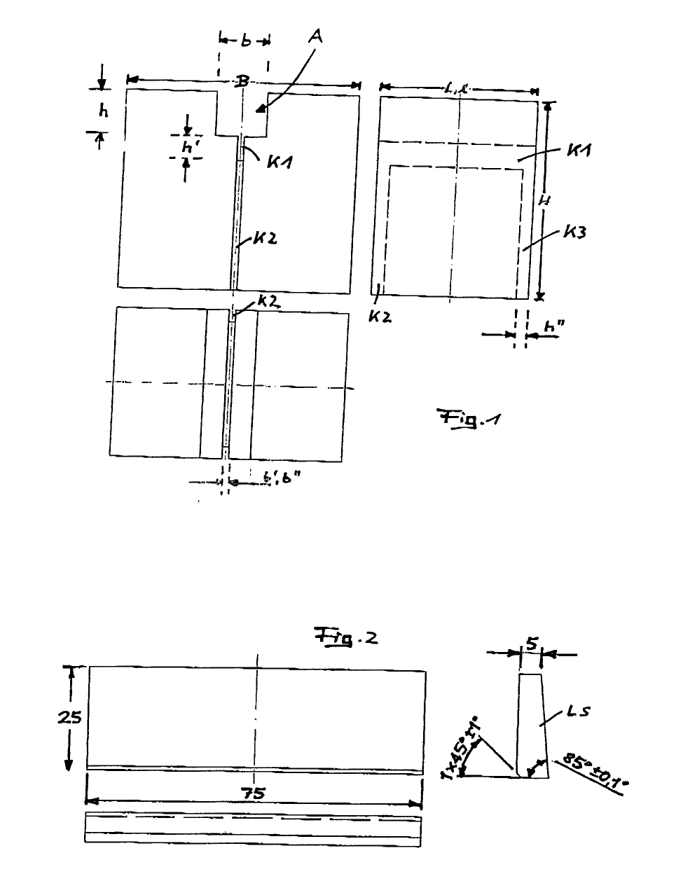

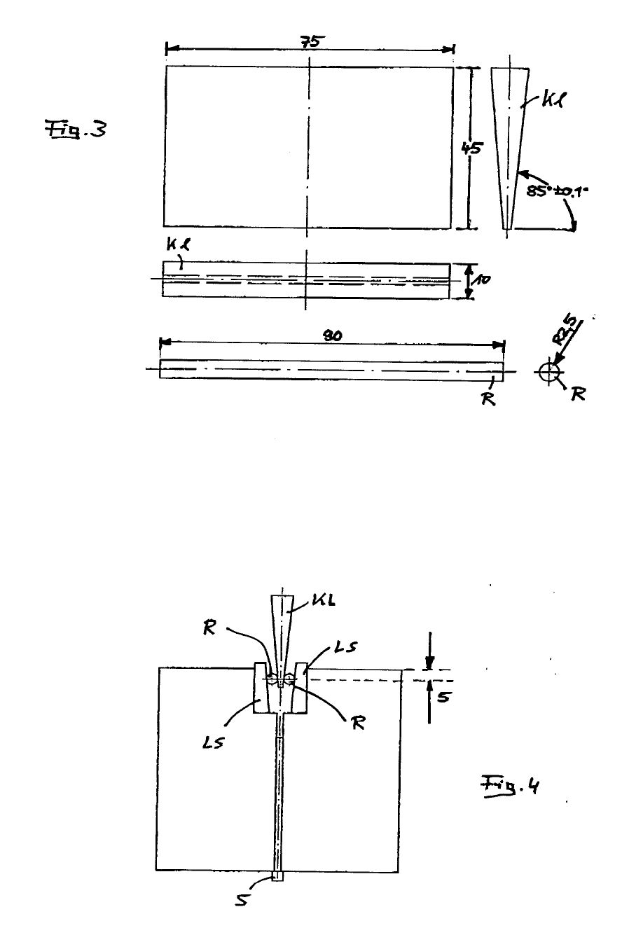

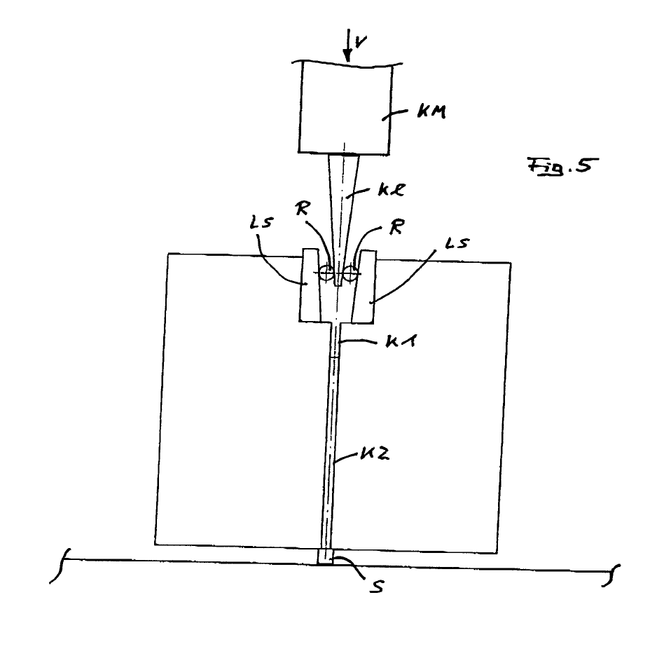

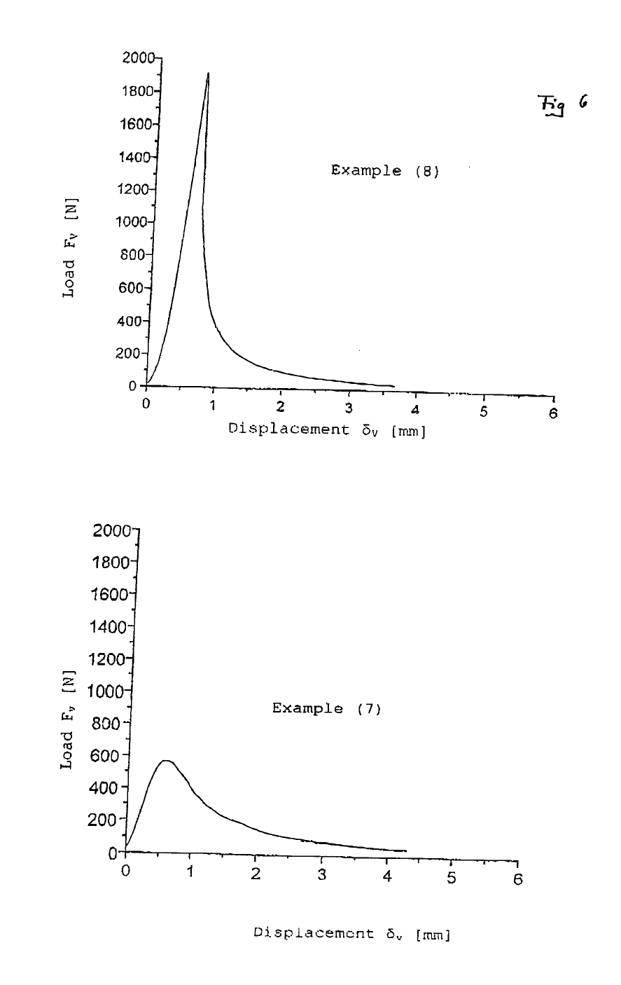

The table given at the end of the description states the conditions for the wedge split test depending on the starting product. “Non-shaped product” designates a batch, where appropriate after addition of a binder and/or a mixing liquid. The term “shaped product” includes all shapes and shaping processes, where the product must have at least the size of the test specimen described in the following. A distinction is made here between shaped products without and after heat treatment and according to their different types of bonding. An “originally non-shaped product”, for example a casting or injection composition, can become compacted during use after establishing a monolithic body (for example a furnace lining) and thus becomes virtually a “shaped product”. This applies analogously to prefabricated components which are exposed to higher temperatures at least during use. At least three test specimens of each product are tested and the mean of the results is used for the evaluation. The shape of the test specimen is shown in FIG. 1. The ashlar-like test specimen has the following dimensions: breadth B: 110 mm, length L: 75 mm, height H: 100 mm. A recess A having the following dimensions can be seen on the upper side: breadth b: 24 mm, length l: 75 mm, height h: 22 mm. The recess A serves to accommodate bars, rollers and a wedge for transmission of energy. A notch K1 having a breadth b′ of 3 mm and a height h′ of 12 mm extends from the base of the recess A downwards in the direction of the base area G. At the end in each case a further notch K2, K3 follow on from the notch K1, running down to the base area G of the test specimen. K2, K3 each have a breadth b″ of 3 mm and a height h″ of 6 mm. For the test, two bars LS, the shape and size of which can be seen from FIG. 2, are inserted in mirror image fashion on the outside into the recess A. A wedge K1 according to FIG. 3 (top) which is supported against the bars LS, as shown in FIG. 4, via two rollers R (FIG. 3 bottom) is placed centrally between the bars LS. When the shaping process of the production of the product takes place by uniaxial pressing, the specimen is removed such that the direction of the pressing force is parallel to the plane of the ligament area (which is that area in which the fracture is generated during testing). The length of the wedge K and of the bars LS corresponds to the specimen length of 75 mm. The rollers R are somewhat longer. Wedge K1, bars LS and rollers R are made of steel. During testing, the test specimen rests on a linear support. This is a four-edged steel rod S which has an edge length of 5 mm and the length of which corresponds at least to the test specimen breadth of 75 mm and extends over the entire length of the test specimen. The rod S overlaps the breadth of the notches K2, K3 uniformly on both sides. FIG. 5 shows the course of the test. A load cell KM can be seen in the upper area of the diagram. The vertical force V applied by loading the wedge K1 by the test machine causes horizontal forces, which lead to a stably progressing formation of cracks during the test. During this, the vertical load F_{V} and the vertical displacement δ_{V} are determined. These parameters are recorded up to a drop in load to 10% or less of the maximum load. The fracture energy G_{F} is determined as the area under the load/displacement curve. It is therefore

$${G}_{F} = \frac{1}{A} {\int }_{o}^{{δ}_{max}} {F}_{v} ⅆ {δ}_{v} \qquad ( II )$$

In this equation (II), A is the ligament area of 66×63 mm² [100−22−12)×(75−6−6), δₘₐₓ is the maximum displacement during the measurement. The nominal notched tensile strength is calculated according to the following equation:

$${σ}_{K Z} = \frac{{F}_{H max}}{B \cdot W} + \frac{6 \cdot {F}_{H max} \cdot y}{B \cdot {W}^{2}} \qquad ( III )$$

In this equation (III), B is the ligament length (63 mm) and W the ligament height (66 mm). The parameter y designates the vertical distance of the line of action of the horizontal force introduced by the rollers from the centre of gravity of the ligament area. A value of 62 mm is used for this as an adequate approximation (FIGS. 1 and 4). The horizontal maximum load F_{Hmax} used in this relationship (III) can be determined from the vertical maximum load F_{Vmax} according to the following relationship:

$${F}_{H max} = \frac{{F}_{V max}}{2 \cdot tan ( α / 2 )} \qquad ( IV )$$

In this relationship (IV), α denotes the wedge angle, which was chosen as 10°. Testing is carried out with a regulated advance at a vertical speed of the die of the test machine of 0.5 mm/min.

In the case where these test parameters cannot be adhered to for a particular product—e.g. because no specimen of adequate size can be produced or for other reasons which raise doubts as to the exactness of the absolute values determined—the quotient G_{F}/σ_{KZ} is determined for the product according to the invention and a product without an SiO₂ carrier produced and tested analogously. In this context, the missing SiO₂ content is added proportionally to all the other components of the product. The reduction in brittleness is then determined from the ratio of the quotient G_{F}/σ_{KZ} for the product according to the invention to the quotient G_{F}/σ_{KZ} for the product without an SiO₂ carrier produced analogously. The ratio is >1, usually >1.5 or >1.8. Values of >2 are aimed for. As the following Examples (7), (8) show, values of almost 3 are achieved.

The comparison values for the specific fracture energy G_{F}, the nominal notched tensile strength σ_{KZ} and the quotient of the two are shown in the following table. Products according to the invention are distinguished by a ratio G_{F}/σ_{KZ} of >40. Values of >50 are aimed for.

| | Example (5) | Comparison Example (6) |
|---|---|---|
| G_{F} [N/m] | 243 | 255 |
| σ_{KZ} [MPa] | 4.6 | 10.7 |
| G_{F}/σ_{KZ} [μm] | 52.8 | 23.8 |

The product according to the invention shows a more than doubled quotient of the specific fracture energy and nominal notched tensile strength, from which a significantly reduced brittleness can be deduced.

| | | Comparison |
|---|---|---|
| | Example (7) | Example (8) |
| Sintered magnesia 1 to 5 mm | 55 | 55 |
| Sintered magnesia 0.125 to <1 mm | 14 | 18 |
| Sintered magnesia <0.125 mm | 27 | 27 |
| Quartzite 0.5 to 1 mm | 4 | |
| Firing temperature ° C. | 1,400 | 1,400 |
| SiO₂ [% by weight] | 4.13 | 0.18 |
| Fe₂O₃ [% by weight] | 0.48 | 0.49 |
| Al₂O₃ [% by weight] | 0.10 | 0.09 |
| CaO [% by weight] | 0.78 | 0.8 |
| MgO (approx.) [% by weight] | 94.5 | 98.4 |
| E_{dyn} [GPa] | 14.9 | 75.8 |
| G_{F} [N/m] | 210 | 264 |
| σ_{KZ} [MPa] | 4.6 | 14.8 |
| G_{F}/σ_{KZ} [μm] | 45.6 | 17.9 |
| σ_{KZ}/E_{dyn} [10⁻³] | 0.31 | 0.20 |

Here also, the wedge split test mentioned was carried out to demonstrate the reduction in brittleness.

FIG. 6 shows the load/displacement graphs of the wedge split test (carried out at room temperature) and demonstrates the significantly less brittle behaviour of the batch (7) according to the invention. In the above table, this can be seen from the higher quotient of the specific fracture energy G_{F} divided by the nominal notched tensile strength σ_{KZ}.

The dynamic modulus of elasticity E_{dyn}, was furthermore determined from the resonance frequency of the extensional wave [Hennicke, Leers: Die Bestimmung elastischer Konstanten mit dynamischen Methoden [Determination of elastic constants by dynamic methods], Tonindustrie-Zeitung 89 no. 23/24, 539-543 (1976)].

As the above table shows, the addition of the granular SiO₂ carrier to the magnesia component causes a significant reduction in the modulus of elasticity, namely from 75.8 GPa to 14.9 GPa.

It can be furthermore seen from the table that the ratio of the nominal notched tensile strength to the dynamic modulus of elasticity is significantly higher in the variant according to the invention. This suggests an increase in the thermal stress parameter R according to Kingery [W. D. Kingery et al.: Introduction to Ceramics, John Wiley & Sons, 1960; ISBN 0-471-47860-1].

Although the invention manages with a simple, inexpensive additive (granular SiO₂ carrier) alongside the refractory base component, the batch mentioned proves to be a good basis for the production of fireproof products which have a relatively low brittleness, and therefore have a good resistance to thermal shock, are corrosion-resistant, but also show no reduction in heat resistance compared with other products from the prior art. The choice of the batch components and production conditions is made such that the product results in a ratio G_{F}/σ_{KZ} of >40.

Compared with magnesia products without a granular SiO₂ carrier, the product according to the invention has the advantage of a higher mechanical or thermomechanical resistance under thermal shock or pronounced deformations. Compared with magnesia chromite products, the advantage of a chromium-free lining material results, as a result of which the risk of the formation of Cr⁶⁺ can be avoided. Compared with spinel products, on the one hand a cost advantage results due to the relatively inexpensively available SiO₂ carrier. On the other hand, building materials in the CaO—MgO—SiO₂ system at weight ratios of CaO to SiO₂ (C/S ratios) of below 0.93, such as are to be expected for products according to the invention, have an invariant point of at least 1,502° C., which at C/S ratios of below approx. 0.25 (existence of a forsterite mixed crystal as the sole silicatic secondary phase) can be increased further to a maximum of approx. 1,860° C. as the C/S ratio decreases.

In contrast, a magnesia brick comprising spinel (MgAl₂O₄) and having a C/S ratio above 1.87, such as corresponds to the prior art, has an invariant point of 1,325° C. The higher invariant point in the product according to the invention can be utilized for improving the heat properties if the amount of fused phase is also more favourable, taking into consideration the product composition and any infiltrates during use. Compared with products with addition of ZrO₂, there is at any rate a more economical advantage on the basis of lower costs of the SiO₂ carrier.

In the case of non-basic products, there is the advantage over the use of mullite or zirconium mullite that no component which comprises a glass phase and therefore results in an adverse influencing of the softening properties is introduced. The product according to the invention allows a material composition which comprises exclusively crystalline phases. A further advantage is that if cristobalite is used, an initiation of microcracks and therefore a reduction in brittleness already occurs at a temperature of 270° C. Non-fired products can therefore also already be produced or employed with a reduced brittleness at a low temperature. These include e.g. casting compositions and prefabricated components. It is also possible, for example, to reduce the brittleness of carbon-bonded non-fired products in this manner.

| | | | Originally non- | |
|---|---|---|---|---|
| | | | shaped product after | Shaped, |
| | Non-shaped | Shaped | compaction by heat | heat-treated |
| | product | product | treatment during use | product with |
| | without | without | (without carbon | ceramic |
| | carbon | carbon | bonding) | bonding |
| Cristobalite/ | 1 | 3 | 5 | 1 |
| tridymite 8 | | | | |
| Other SiO₂ | 2 | 4 | 6 | 1 |
| carrier 9 | | | | |
| | | | Originally non- | |
| | | | shaped product after | Shaped, |
| | Non-shaped | Shaped | compaction by heat | heat-treated |
| | produce | product | treatment during use | product with |
| | with | with | (with carbon | carbon |
| | carbon | carbon | bonding) | bonding |
| Cristobalite/ | 1* | 3* | 5* | 3* |
| tridymite 8 | | | | |
| Other SiO₂ | 2* | 4* | 6* | 4* |
| carrier 9 | | | | |
| | | | Originally non- | |
| | | | shaped product after | Shaped, |
| | | | compaction and heat | heat-treated |
| | | | treatment during use | product with |
| | | | (with chemical | chemical |
| | | | bonding) | bonding |
| Cristobalite/ | | | 5 | 3 |
| tridymite 8 | | | | |
| Other SiO₂ | | | 6 | 4 |
| carrier 9 | | | | |
| | | | Originally non- | |
| | | | shaped product after | Shaped, |
| | | | compaction and heat | heat-treated |
| | | | treatment during use | product with |
| | | | (with hydraulic | hydraulic |
| | | | bonding) | bonding |
| Cristobalite/ | | | 5 | 3 |
| tridymite 8 | | | | |
| Other SiO₂ | | | 6 | 4 |
| carrier 9 | | | | |

In this table, the meanings are as follows:
1: A test specimen is shaped from the batch, where appropriate after addition of a binder and/or water (for example: chemical or hydraulic binder), and this is heat-treated at 350° C.
2: A test specimen is shaped from the batch, where appropriate after addition of a binder and/or water (for (example: chemical or hydraulic binder), and this is heat-treated at 650° C. or alternatively ≧1,350° C.
3: A test specimen is cut out of the product and this is heat-treated at 350° C. if the product has not already been heat-treated at a temperature of ≧350° C. beforehand.
4: A test specimen is cut out of the product and this is heat-treated at 650° C. or alternatively 1,350° C. if the product has not already been heat-treated at a temperature of ≧650° C. or alternatively ≧1,350° C. beforehand.
5: A test specimen is cut out of the product formed during use and this is heat-treated at 350° C. if the product has not already been heat-treated at ≧350° C. during use.
6: A test specimen is cut out of the product formed during use and this is heat-treated at 650° C. or alternatively 1,350° C. if the product has not already been heat-treated at ≧650° C. or alternatively 1,350° C. during use.
7: A test specimen is cut out of the product.
8: The SiO₂ carrier comprises cristobalite and/or tridymite to the extent of at least 50 wt. %.
9: The SiO₂ carrier comprises cristobalite and/or tridymite to the extent of less than 50 wt. %.
In 4. and 6., the heat treatment is conventionally carried out at 1,350° C. If the temperature of 1,350° C. is too high to achieve a reduction in brittleness, the heat treatment is alternatively carried out at 650° C., which is above the temperature for the quartz crack.
*with a reducing atmosphere during the heat treatment

1. Ceramic batch for fireproof uses, comprising
A) 83-99.5 wt. % of at least one refractory base material in a grain fraction of <8 mm and
B) 0.5-12 wt. % of at least one separate, granular SiO₂ carrier, and
C) any remainder: other constituents.

2. Hatch according to claim 1, at least some of the refractory base material of which is a non-basic base material.

3. Batch according to claim 1, at least some of the refractory base material of which comprises doloma and/or magnesia.

4. Batch according to claim 1, comprising
A) 90-99 wt. % of the refractory base material, and
B) 1-7 wt. % of the granular SiO₂ carrier.

5. Batch according to claim 1, the granular SiO₂ carrier of which comprises at least one of the following SiO₂ modifications: cristobalite, tridymite, coesite, a pretreated product having a bulk density of <2.65 g/m³.

6. Batch according to claim 1, the SiO₂ carrier of which has a grain size d₅₀ which is greater than 95 wt. % of the fine grain content of the refractory base material.

7. Batch according to claim 1, the SiO₂ carrier of which has a grain size d₀₅ which is greater than 95 wt. % of the fine grain content of the refractory base material.

8. Batch according to claim 1, the refractory base material of which has a fine grain content with 95 wt. %<250 μm.

9. Batch according to claim 1, the refractory base material of which has a fine grain content with 95 wt. %<125 μm.

10. Batch according to claim 9, of which the fine grain content of the refractory base material is 10-30 wt. % of the total batch.

11. Batch according to claim 1, the SiO₂ carrier of which has a grain size of up to 6 mm.

12. Batch according to claim 1, the SiO₂ carrier of which has a grain size of up to 3 mm.

13. Batch according to claim 1, the SiO₂ carrier of which has a grain size of between 0.5 and 3 mm.

14. Batch according to claim 1, the refractory base material of which has a grain size of <6 mm.

15. Batch according to claim 1, the refractory base material of which has the following grain distribution:
a) 50-60 wt. % 1-6 mm,
b) 10-25 wt. % 0.25-<1 mm,
c) 25-30 wt. %<0.25 mm
the sum being 100 wt. %.

16. Batch according to claim 1, comprising a non-basic refractory base material of at least one of the following components: chamotte, sillimanite, andalusite, kyanite, mullite, bauxite, corundum raw materials, such as fused corundum or brown corundum, tabular alumina, calcined alumina, quartzite, base materials containing zirconium oxide, such as zirconium mullite, zirconium corundum, zirconium silicate or zirconium oxide, titanium oxide, Mg—Al-spinel, silicon carbide.

17. Batch according to claim 1, comprising an MgO base material which comprises a spinel of the herzynite type, the galaxite type or mixtures thereof to the extent of 3 to 20 wt. %, based on the total mixture.

18. Batch according to claim 1, which comprises as other constituents at least one of the following components: carbon, graphite, resin, pitch, carbon black, coke, tar.

19. Product based on a batch according to claim 1, having a quotient of the specific fracture energy G_{f} (N/m) and nominal notched tensile strength σ_{K2} (MPa) of >40 μm, in each case determined by means of the wedge split test on a test specimen as described herein.

20. Product based on a batch according to claim 1, having a quotient of the specific fracture energy G_{F} (N/m) and nominal notched tensile strength σ_{Kz} (MPa), in each case determined by means of the wedge split test on a test specimen as described herein, which is at least 1.5 times the quotient, determined in the same way, for an analogous product without a separate, granular SiO₂ carrier, the other base constituents of which are adjusted proportionally by the missing SiO₂ content to give 100 wt. % in total.
